(19) United States
(12) Patent Application Publication
(10) Pub. No.: US 2016/0059892 A1
(43) Pub. Date: Mar. 3, 2016

(54) REAR STRUCTURE OF FRONT SIDE MEMBER

(71) Applicant: HYUNDAI MOTOR COMPANY, Seoul (KR)

(72) Inventor: Sun Ju LEE, Incheon (KR)

(21) Appl. No.: 14/602,922

(22) Filed: Jan. 22, 2015

(30) Foreign Application Priority Data
Sep. 3, 2014 (KR) 10-2014-0117089

(51) Int. Cl. B62D 21/15; B62D 25/14; B62D 25/02

(52) U.S. Cl. CPC B62D 21/152; B62D 25/025; B62D 25/145

(57) ABSTRACT

A rear structure of a front side member includes a front side member to which collision energy is delivered at the time of a head-on collision of a vehicle body, a front side rear lower member configured to extend from the front side member to a center floor panel formed at a rear end of the front side member, and a front side rear upper reinforcement member configured to extend from the front side member to a front pillar lower member and suppress bending of the front side member occurring due to a moment in a pitch direction. Thus, it is possible to prevent the front side member from being deformed upward by delivering the collision energy from the front side member to the front side rear lower member and the front side rear upper reinforcement member at the time of the head-on collision.

### CROSS-REFERENCE TO RELATED APPLICATION

This application is based on and claims the benefit of priority to Korean Patent Application No. 10-2014-0117089, filed on Sep. 3, 2014 in the Korean Intellectual Property Office, the disclosure of which is incorporated herein in its entirety by reference.

### TECHNICAL FIELD

The present disclosure relates to a rear structure of a front side member, and more particularly, to a rear structure of a front side member capable of securing sectional connectivity between structures of a vehicle body and increasing stiffness of the vehicle body.

### BACKGROUND

Generally, a skeletal structure of a vehicle is configured of two side members configuring sides of a vehicle body and a plurality of cross members which are positioned to cross the side members and have opposite ends coupled with the side members.

The plurality of cross members are coupled with the side members from a front end portion of the vehicle body to a rear end portion thereof, in which the side member is called a front side member, a front side rear member, and a rear side member depending on positions at which the cross members are coupled or a position of a floor panel. Meanwhile, a side of the vehicle is provided with a side sill protecting a cabin at the time of a side collision and forming an appearance of the side.

As illustrated in FIG. 1, as a lower structure of the vehicle body according to the related art has a rear on a dash panel 1 basis provided with a cabin 2, the front side member 3 is bent at a predetermined angle, passing through a dash panel 1 and extends to a lower portion of the cabin to form a front side rear lower member 4 which is positioned under the cabin.

Collision energy generated at the time of a head-on collision is delivered to the front side rear lower member 4 through the front side member 3. In this case, the collision energy is concentrated on a bent portion and thus the front side member 3 may be deformed upward at the time of the head-on collision. When the front side member 3 is deformed upward, an engine and other parts within an engine room move backward, and thus the cabin 2 may be deformed.

### RELATED ART DOCUMENT

### Patent Document

Korean Patent Laid-Open Publication No. 10-2010-0058973 (published on Jun. 4, 2010).

### SUMMARY

The present disclosure has been made to solve the above-mentioned problems occurring in the prior art while advantages achieved by the prior art are maintained intact.

An aspect of the present disclosure provides a rear structure of a front side member capable of preventing a front side member from being deformed upward at the time of a head-on collision, securing sectional connectivity between structures of a vehicle body, and increasing stiffness of the vehicle body.

According to an exemplary embodiment of the present invention, a rear structure of a front side member for preventing the front side member from being deformed upward due to a collision includes: the front side member to which collision energy is delivered at the time of a head-on collision of a vehicle body; a front side rear lower member configured to extend from the front side member to a center floor panel formed at a rear end of the front side member; and a front side rear upper reinforcement member configured to extend from the front side member to a front pillar lower member and suppress bending of the front side member occurring due to a moment in a pitch direction.

According to another exemplary embodiment of the present invention, a rear structure of a front side member includes: a front side member to which collision energy is delivered at the time of a head-on collision of a vehicle body and be provided with a front side member extension to extend to a center floor panel; a front side rear lower member configured to extend from the front side member to the center floor panel through the front side member extension; a side sill configured to extend from the front side member to a side of the center floor panel through the front side member extension; and a front side rear upper reinforcement member configured to extend from the front side member to a front pillar lower member.

According to another exemplary embodiment of the present invention, a skeletal structure of a vehicle may include a front side member extending from a first end to a second end, a front side rear lower member including a first portion coupled between the second end of the front side member and a second portion of the front side rear lower member, and a front side rear upper reinforcement member coupled to the second end of the front side member. The second portion of the front side rear lower member may extend in a direction substantially parallel to a direction from the first end to the second end of the front side member. The front side rear upper reinforcement member and the front side rear lower member may be disposed at opposite sides of the front side member.

The skeletal structure of a vehicle may further include a dash cross side member connected to the front side rear upper reinforcement member and a dash cross lower member connected to the front side rear lower member. The front side rear upper reinforcement member, and the dash cross side member, dash cross lower member and front side rear lower member may be disposed at opposite sides of the front side member.

The first portion of the front side rear lower member may be coupled to the front side member via a front side member extension bent from the second end of the front side member, and the front side member extension may be coupled between the front side rear upper reinforcement member and the second end of the front side member.

The skeletal structure of a vehicle may further include a side sill coupled to the second end of the front side member. The side sill and the front side rear lower member may be disposed at opposite sides of the front side member.

The skeletal structure of a vehicle may further include a rear side member connected to the side sill and extending in a lengthwise direction of the side sill. The rear side member may have a section in a direction vertical to a lengthwise direction of the rear side member formed in a ‘ [symbol] ’-letter shape.

The front side member, the front side member extension and the side sill may have a section in a direction vertical to a lengthwise direction formed in a ‘ [symbol] ’-letter shape.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a perspective view and a plan view of a structure of a vehicle body according to the related art and a side view of a main part thereof;

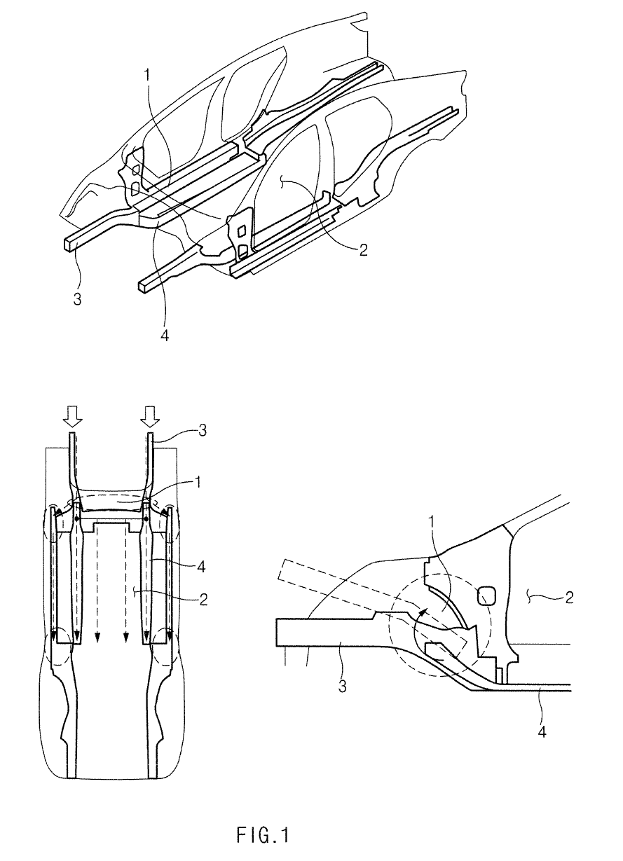

FIG. 2 is a perspective view of a main part of a rear structure of a front side member according to an exemplary embodiment of the present invention;

FIG. 3 is an exploded perspective view of the main part of the rear structure of a front side member of FIG. 2;

FIG. 4 is another perspective view of the main part of the rear structure of a front side member of FIG. 2;

FIG. 5 is another perspective view of the rear structure of a front side member of FIG. 2;

FIG. 6 is a plan view of the rear structure of a front side member of FIG. 2;

FIG. 7 is a plan view of the main part of the rear structure of a front side member of FIG. 2; and

FIG. 8 is a side cross-sectional view of the main part of the rear structure of a front side member of FIG. 2.

### DETAILED DESCRIPTION

Exemplary embodiments of the present disclosure will be described in detail with reference to the accompanying drawings.

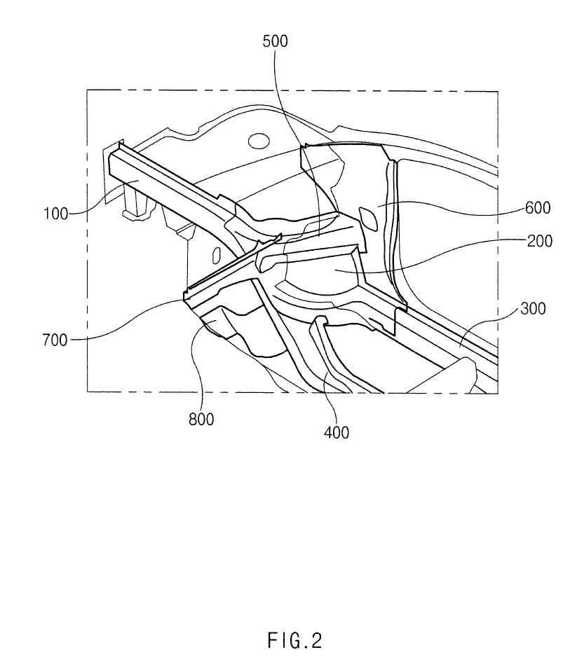

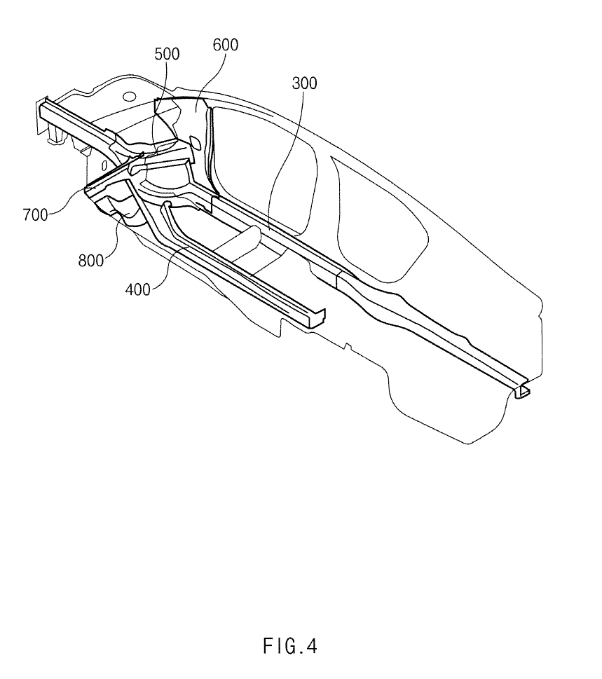

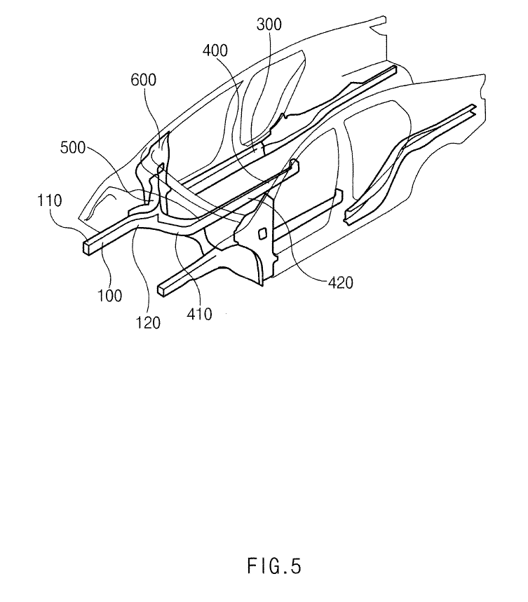

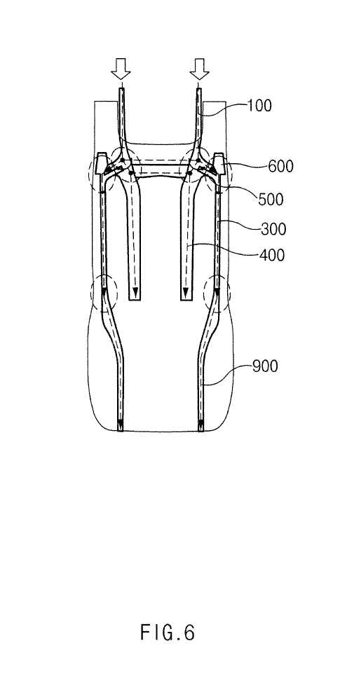

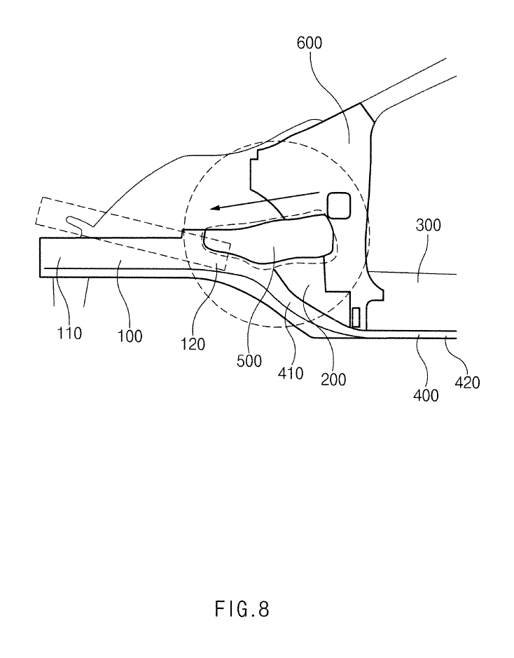

As illustrated in FIGS. 2 through 8, a rear structure of a front side member according to an exemplary embodiment of the present invention includes a front side member 100 to which collision energy is delivered at the time of a head-on collision of a vehicle body, a front side rear lower member 400 configured to extend from the front side member 100 to a center floor panel formed at a rear end of the front side member 100, and a front side rear upper reinforcement member 500 configured to extend from the front side member 100 to a front pillar M lower member 600 and suppress bending of the front side member 100 occurring due to a moment in a pitch direction. The front side member 100 extends from a first end 110 to a second end 120. The front side rear lower member 400 includes a first portion 410 coupled between the second end 120 of the front side member 100 and a second portion 420 of the front side rear lower member 400. The second portion 420 of the front side rear lower member 400 extends in a direction substantially parallel to a direction from the first end 110 to the second end 120 of the front side member 100. The front side rear upper reinforcement member 500 coupled to the second end 120 of the front side member 100. The front side rear upper reinforcement member 500 and the front side rear lower member 400 are disposed at opposite sides of the front side member 100.

The front side rear lower member 400 is connected to a bent front side member extension 200 to suppress the front side member extension 200 from being bent laterally and is connected to the front side rear upper reinforcement member 500 through the front side member extension 200 to prevent the front side member 100 from being vibrated and deformed laterally due to a forward collision or a surrounding environment. The rear structure of a front side member according to an exemplary embodiment of the present disclosure further includes a side sill 300 configured to extend from the front side member 100 to the center floor panel and absorb the collision energy applied in a vehicle shaft direction. The side sill 300 and the front side rear lower member 400 are disposed at opposite sides of the front side member 100.

The rear structure of a front side member according to an exemplary embodiment of the present disclosure configured as described above will be described below in more detail. The front side member 100 is bent, passing through a dash panel to extend to the side sill 300 and the front side rear lower member 400 which are positioned at a side and a lower surface of the center floor panel, in which the bent portion is the front side member extension 200.

The front side rear lower member 400 extends from the front side member 100 to the center floor panel through the front side member extension 200. In this case, the front side rear lower member 400 is welded to the front side member 100 through a connection part 210. The side sill 300 is formed to seamlessly extend from the front side member 100 to the side of the center floor panel through a curvature of the front side member extension 200.

The front side rear upper reinforcement member 500 extends from the front side member 100 to the front pillar lower member 600.

The front side member 100 is bent, passing through the dash panel to form the side sill 300 and the front side rear lower member 400 which are positioned at a side and a lower surface of the cabin. The bent portion of the front side member 100 is the front side member extension 200.

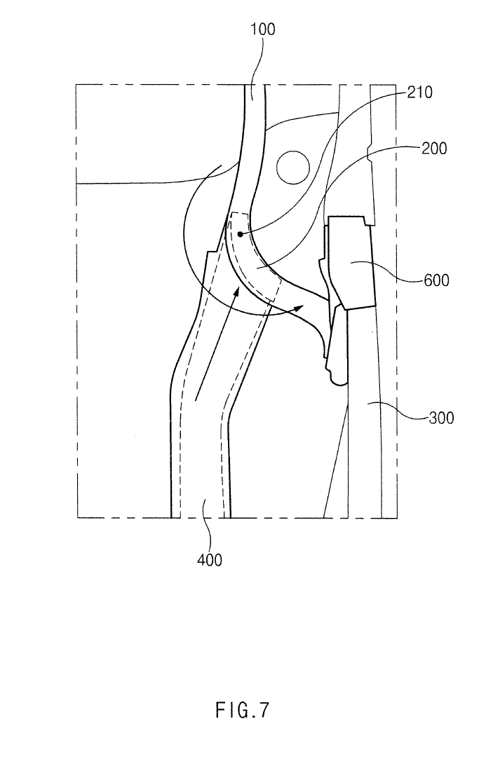

The bent portion of the front side member extension 200 is connected to the front side rear lower member 400, and as a result, a moment generated at the bent portion is minimized, thereby minimizing a horizontal shaking of the front side member. Further, a load of the cabin applied to the front side rear lower member 400 at the time of the collision is dispersed to the front side member and the side sill 300, such that energy absorption is increased (see FIG. 7).

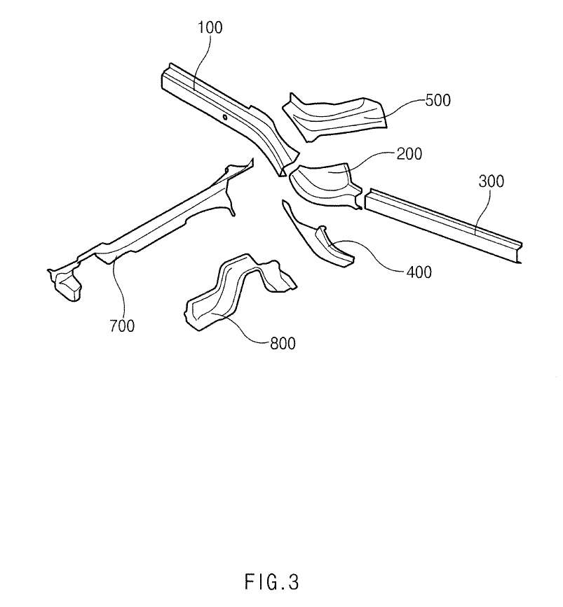

According to the exemplary embodiment of the present disclosure, as illustrated in FIG. 3, the front side member 100 and the front side rear upper reinforcement member 500 each are separately manufactured and then are connected to each other by a welding.

At the time of the head-on collision, the collision energy concentrated on the front side member 100 is delivered to the side sill 300 and the front pillar lower member 600 through the front side rear upper reinforcement member 500 and the front side member extension 200. As a result, it is possible to minimize a deformation of an inside of the cabin and increase residual energy within the vehicle.

A dash cross side member 700 mounted in the dash panel is connected to the front side rear upper reinforcement member 500 and a dash cross lower member 800 mounted in the dash panel is connected to the front side rear lower member 400, such that the connection between the dash panel and the front side member is strong. The front side rear upper reinforcement member 500, and the dash cross side member 700, dash cross lower member 800 and front side rear lower member 400 are disposed at opposite sides of the front side member 100.

According to the exemplary embodiment of the present disclosure, a section in a direction vertical to a lengthwise direction of the front side member 100, a section in a direction vertical to a lengthwise direction of a the front side member extension 200, and a section in a direction vertical to a lengthwise direction of the side sill 300 all are manufactured to have a ‘ [symbol] ’-letter shape. ‘ [symbol] ’-letter shape refers to a shape substantially the same as a U-shape or a shape substantially the same as a U-shape with right angle bends.

Since the section of the front side member 100 and the section of the side sill 300 have the same ‘ [symbol] ’-letter shape, the connection between the front side member 100 and the side sill 300 becomes stronger. As a result, the stiffness of the vehicle body is more increased.

Further, according to the exemplary embodiment of the present invention, the rear side member 900 is formed to extend in a lengthwise direction of the side sill 30. Like the side sill 300, the rear side member 900 is manufactured so that the section vertical to a lengthwise direction thereof has the [symbol] letter shape. The front side member 100, the side sill 300, and the rear side member 900 are connected to the same ‘ [symbol] ’-letter shape section, such that the connection among the front side member 100, the side sill 300, and the rear side member 900 may be strong and the collision energy may be easily delivered.

At the time of the head-on collision, the collision energy is delivered from the front side member 100 to the rear side member 900 through the front side member extension 200 and the side sill 300, such that the absorption of the collision energy may be maximized and the deformation of the cabin may be minimized. Further, even at the time of the rear collision, the collision energy is delivered from the rear side member 900 to the front side member 100 through the side sill 300, thereby minimizing the deformation of the cabin.

According to the rear structure of a front side member according to the exemplary embodiments of the present invention, it is possible to prevent the front side member from being deformed upward by delivering the collision energy from the front side member to the front side rear lower member and the front side rear upper reinforcement member at the time of the head-on collision.

Further, it is possible to minimize the behavior of the passenger by preventing the front side member from being M deformed upward.

Further, it is possible to increase the stiffness of the vehicle body by connecting the front side member to the side sill.

Further, it is possible to support the horizontal shaking of the front side member and dispersedly support the load by making the front side member extend to the front side rear lower member and the side sill through the front side member extension.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A rear structure of a front side member for preventing the front side member from being deformed upward due to a collision, the rear structure comprising:
the front side member to which collision energy is delivered at the time of a head-on collision of a vehicle body;
a front side rear lower member extending from the front side member to a center floor panel formed at a rear end of the front side member; and
a front side rear upper reinforcement member extending from the front side member to a front pillar lower member to suppress bending of the front side member occurring due to a moment in a pitch direction.

2. The rear structure of a front side member according to claim 1, wherein the front side rear lower member is connected to a front side member extension bent from the front side member to suppress the front side member extension from being bent laterally, and the front side member extension is connected to the front side rear upper reinforcement member.

3. The rear structure of a front side member according to claim 1, further comprising a side sill extending from the front side member to the center floor panel to absorb the collision energy applied in a vehicle shaft direction.

4. A rear structure of a front side member, comprising:
a front side member to which collision energy is delivered at the time of a head-on collision of a vehicle body and provided with a front side member extension to extend to a center floor panel;
a front side rear lower member extending from the front side member to the center floor panel;
a side sill extending from the front side member to a side of the center floor panel through the front side member extension; and
a front side rear upper reinforcement member extending from the front side member to a front pillar lower member.

5. The rear structure of a front side member according to claim 4, wherein the front side rear upper reinforcement member is coupled with the front side member extension.

6. The rear structure of a front side member according to claim 4, further comprising:
a dash cross side member connecting the front side rear upper reinforcement member to a dash panel; and
a dash cross lower member connecting the front side rear lower member to the dash panel.

7. The rear structure of a front side member according to claim 4, wherein the front side member, the front side member extension and the side sill have a section in a direction vertical to a lengthwise direction formed in a ‘ [symbol] ’-letter shape.

8. The rear structure of a front side member according to claim 7, further comprising a rear side member extending in a lengthwise direction of the side sill, wherein the rear side member has a section in a direction vertical to a lengthwise direction of the rear side member formed in a ‘ [symbol] ’-letter shape.

9. A skeletal structure of a vehicle, comprising:
a front side member extending from a first end to a second end;
a front side rear lower member including a first portion coupled between the second end of the front side member and a second portion of the front side rear lower member, the second portion of the front side rear lower member extending in a direction substantially parallel to a direction from the first end to the second end of the front side member; and
a front side rear upper reinforcement member coupled to the second end of the front side member, the front side rear upper reinforcement member and the front side rear lower member disposed at opposite sides of the front side member.

10. The skeletal structure of a vehicle according to claim 9, further comprising:
a dash cross side member connected to the front side rear upper reinforcement member; and
a dash cross lower member connected to the front side rear lower member,
wherein the front side rear upper reinforcement member, and the dash cross side member, dash cross lower member and front side rear lower member are disposed at opposite sides of the front side member.

11. The skeletal structure of a vehicle according to claim 9, wherein the first portion of the front side rear lower member is coupled to the front side member via a front side member extension bent from the second end of the front side member, and the front side member extension is coupled between the front side rear upper reinforcement member and the second end of the front side member.

12. The skeletal structure of a vehicle according to claim 11, further comprising a side sill coupled to the second end of the front side member, the side sill and the front side rear lower member disposed at opposite sides of the front side member.

13. The skeletal structure of a vehicle according to claim 12, further comprising a rear side member connected to the side sill and extending in a lengthwise direction of the side sill, wherein the rear side member has a section in a direction vertical to a lengthwise direction of the rear side member formed in a ‘ [symbol] ’-letter shape.

14. The skeletal structure of a vehicle according to claim 12, wherein the front side member, the front side member extension and the side sill have a section in a direction vertical to a lengthwise direction formed in a ‘ [symbol] ’-letter shape.
